(19) United States
(12) Patent Application Publication
(10) Pub. No.: US 2015/0141880 A1
(43) Pub. Date: May 21, 2015

(54) METHODS AND DEVICES OF PROVIDING MECHANICAL STIMULATION TO THE BODY

(71) Applicant: Sympara Medical, Inc., San Francisco, CA (US)

(72) Inventor: Kevin Joe Ehrenreich, San Francisco, CA (US)

(21) Appl. No.: 14/401,481

(22) PCT Filed: May 16, 2013
(86) PCT No.: PCT/US13/41465

§ 371 Date: Nov. 14, 2014

Related U.S. Application Data
(60) Provisional application No. 61/648,060, filed on May 16, 2012.
(60) Provisional application No. 61/648,081, filed on May 17, 2012.
(60) Provisional application No. 61/648,082, filed on May 17, 2012.
(60) Provisional application No. 61/648,083, filed on May 17, 2012.

(51) Int. Cl. A61H 23/00

(52) U.S. Cl. CPC A61H 23/00
USPC 601/47

(57) ABSTRACT

A device for treating pain. In some embodiments, the device includes a housing, the housing having a proximal end, a distal end defining a volume therebetween, the housing further including a first surface and a second surface; a driver member disposed within the volume of the housing; an energy source disposed within the volume of the housing; and an electronic module disposed within the volume of the housing, wherein the electronics module is coupled to the driver member and the energy source. The invention also includes methods of using the device to treat a subject.

### CROSS REFERENCE TO RELATED APPLICATIONS

This application claims the benefit of U.S. Application No. 61/648,060 filed May 16, 2012; U.S. Application No. 61/648,081, filed May 17, 2012; U.S. Application No. 61/648,082, filed May 17, 2012; and U.S. Application No. 61/648,083, filed May 17, 2012, the disclosures of which are incorporated herein by reference.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

The present invention relates to methods and devices for applying mechanical energy to the body (e.g., vibratory energy and/or acoustic energy) to treat a variety of conditions.

It is well known that approximately one out of every ten people suffer from some type of back pain, but still manage to function on a day-to-day basis. It is also well known that these back pains are often aggravated by long periods of physical inactivity, such as while driving or working at a desk. Unfortunately, such periods of physical inactivity are frequently required as part of one's employment. However, when a worker is suffering from such back pain, their efficiency will decrease and they will often be irritable, which will have a negative effect on their fellow employees and, hence, on the productivity of the entire organization.

Back pain is such a common problem, numerous attempts have been made heretofore to alleviate or reduce such pain. Heating pads are widely used for the treatment of back pain. However, heat alone is generally only partially effective. Massage, also, is widely used to alleviate back pain. Numerous types of massage machines have been proposed to meet these needs. Unfortunately, most of these prior art devices have been passive devices which require a user to rub against the device or to manually rub the device over the area to be treated to obtain massaging action. Other prior art devices offer vibration to reduce back pain. However, these devices just generally provide general vibrations.

There is a need for an improved device utilizing vibrations, acoustic energy, ultrasonic energy to treat back or sciatic nerve pain.

In addition to back pain as described above, many people suffer from other pain. For example, they may experience pain in their knees, elbows, shoulders, hands, etc. There is a need for a device to treat these areas of pain using acoustical energy.

Multiple Sclerosis (MS) is a debilitating disease in which the myelin surrounding the nerves is damaged, resulting in inhibition of nerve communication and impairment of physical and cognitive abilities. There is currently no cure for MS, but management of the disease has been advanced through the use of medical treatments, diet, and other non-surgical means. These treatments reflect the lack of a known cause of MS. MS sufferers apparently have a high prevalence of narrowing, twisting, or blockage of the veins that remove blood from the main extracranial cerebrospinal veins, the jugular, and the azygous venous systems. These abnormalities cause blood “refluxing”, or retrograde flow, which creates reflux in the central nervous system. As a result, pooling of non-oxygenated blood can occur along with pericapillary iron deposition. Since iron is known to create free radicals that are toxic to cells, it is hypothesized that the MS inflammations may be caused by these iron deposits as seen in CVD, mentioned above. The high iron content of MS patients' brains has been confirmed. The work led to the coining of the venous disorder Chronic Cerebrospinal Venous Insufficiency (CCSVI).

Veins are thin structures that lack some of the muscular features of arteries. Thus, distension of the veins is common. In the internal jugular vein, MS sufferers can develop distension and bulging. These bulbs can expand, or the entire length of vessel, or a substantial portion thereof, may expand, which causes blood accumulation and reflux as described above. Further, the venous system, and particularly the jugular portion of the venous system, includes valves that operate to allow blood to flow easily in one direction but resist the backflow of blood in the opposite direction. Veins can distend near the venous valves, and this distention can occur on either side of the valve. For example, the vein may have a barbell shape with the valve in the handle area. Thus, the valve can act as a stenosis that restricts blood now in both directions and thereby inhibits now. Poor venous drainage and the resulting deposition of iron may be a primary or secondary cause of other diseases as well. For example, beyond MS, the treatment of CCSVI can also help prevent or treat dementia, Alzheimer's disease, or other diseases of the central nervous system.

There is a need to cause activation of a malfunctioning venous valve without causing damage to the valve or to return a venous valve to a functioning state.

Sexual dysfunction describes the condition where a mammal is unable to develop or maintain an erection of the genitalia or achieve orgasm or arousal. The condition is distressing and can significantly diminish the quality of life for those affected and for their partners and it is estimated that around 18 million people in the US alone suffers from sexual dysfunction.

Prostate cancer screening programs have led to thousands of sexually healthy men being diagnosed with prostate cancer every year. Recent literature suggests that up to 80% of these cancers are confined to the prostate gland. Currently, radical prostatectomy (RP) remains the best option for management of localized prostate cancer in men with life expectancy greater than 10 years. Other options for management of localized prostate cancer include external beam radiation, radioactive seed implant, focal or total cryotherapy and active surveillance.

Erectile dysfunction (ED) after nerve-sparing prostate cancer surgery, or other nerve-sparing pelvic surgery, such as radical rectal or bladder surgery, as well as cancer related pelvic radiation or cryotherapy, is related to a certain degree with functional impairment of one or both (left, right) cavernous nerves (CN), also known as “neurovascular bundles” that travel on each side of the prostate gland to the genitalia. These nerves carry important pro-sexual (parasympathetic) autonomic information from the central nervous system via the sacral spinal cord to the penile sexual tissues.

After a nerve sparing radical prostatectomy a substantial part of the patients will develop erectile dysfunction (72% after 5 years). As this side effect significantly diminishes the quality of life for the patient, the risk of this side effect causes many patients to postpone the decision to have an operation.

Studies have shown that the dorsal nerve plays a crucial role in erections. It is especially important for rigid erections necessary for sexual intercourse. Damage to the dorsal nerve in animal studies inhibits successful sexual intercourse. The evolutionary process of the stroking movement of the male genitalia and the thrust action of sexual intercourse persistently excites the dorsal nerve fibers and perineal nerve fibers of the genitalia to send information to the spinal cord to provoke cavernous nerves, through complex penile and spinal connections, to release pro-sexual neurotransmitters from their nerve endings throughout corporal tissues, leading to initiation and maintenance of erection.

Today erectile dysfunction is treated by phophodiesterase-5 inhibitors, vacuum erection devices, intracavernous injections or intraurethral applications of prostaglandins and penile implants with varying results. In the case of pharmaceutical products, the user must take the pharmaceutical product hours before intercourse. The existing vacuum devices are bulky and large, and generally do not lend themselves well to discrete use.

Therefore there is a need for device and associated methods to address sexual dysfunction, particularly a device and methods that can be used discretely and provide results quickly.

### SUMMARY OF THE DISCLOSURE

The present invention relates to devices and methods that apply mechanical energy to a human body to treat conditions and syndromes.

One aspect of the invention provides a device for treating back or sciatic nerve pain. The device utilizes a therapy providing device, the therapy providing device includes a housing having a driver member, energy source and an electronics module disposed therein.

In certain embodiments in accordance with one aspect of the present invention the driver member disposed within the housing is a coil speaker. The electronics module controls the action of the speaker, the electronics controls the motion of speaker to deliver a sound wave having a frequency in the range of 0 to 20,000 Hz, preferably 1 to 100 Hz and more preferably 10 to 60 and most preferably 15 to 45 Hz. The therapy may be provided for a time period between 1 minute and 24 hours, 1 day to 7 days a week.

In another embodiment in accordance with the present invention, the driver member is a piezoelectric speaker. The electronics module controls the action of the piezoelectric speaker to deliver a sound wave for therapy.

In accordance with the present invention there is provided a device and methods for the treatment of knee pain. The device utilizes a therapy providing device, the therapy providing device includes a housing having a driver member energy source and an electronics module disposed therein.

This aspect of the invention provides a device for treating pain. In some embodiments, the device includes a housing, the housing having a proximal end, a distal end defining a volume therebetween, the housing further including a first surface and a second surface; a driver member disposed within the volume of the housing; an energy source disposed within the volume of the housing; and an electronic module disposed within the volume of the housing, wherein the electronics module is coupled to the driver member and the energy source. In some embodiments, the electronic module includes a wireless communication module.

In some embodiments, the device also includes a computing device. The computing device may have a wireless communication module adapted to communicate with the electronic module. The computing device may also have a software program configured to operate the driver member.

In some embodiments, the driver member is adapted to produce vibratory energy at a frequency in the range of 0 Hz to 100 Hz, or 10 Hz to 60 Hz, or 15 Hz to 45 Hz.

Another aspect of the invention provides a method of treating pain including the steps of applying vibratory stimulation to the body at a frequency of 0 to 100 Hz for a time period between 1 minute and 24 hours. The method may also include the step of applying the vibratory stimulation for a time period between 1 day to 7 days a week.

Another aspect of the invention provides a device and method for treatment of various venous conditions, including CCSVI. In accordance with such invention a device and methods are provided which utilizes sound waves or vibrations to target venous valve leaflets.

Yet another aspect of the invention provides a method of treating venous insufficiency including the steps of applying acoustic energy to a subject's clavicle and delivering acoustic energy to venous valves of the subject. In some embodiments, the acoustic energy is provided at a frequency between 135 Hz and 155 Hz.

Yet another aspect of the invention provides devices and methods which utilize sound waves or vibrations to target nerve endings to treat sexual function or dysfunction. An exemplary method for treating a subject's sexual function includes the steps of placing a therapy device against the subject adjacent the pudendal nerve and applying mechanical vibrations to the subject at a frequency between 100 Hz and 200 Hz. In embodiments in which the sexual function is male penile erection, the placing step may include the step of placing the therapy device against pubic tissue of the subject, the applying step comprising the subject controlling application of the mechanical vibrations. In embodiments in which the sexual function is female arousal, the applying step may include the step of the subject controlling application of the mechanical vibrations.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is an exemplary embodiment of the system in accordance with an embodiment of the present invention;

FIG. 2 is a perspective view of the housing of the therapy device in accordance with an embodiment of the present invention; and

FIG. 3 is a cross-sectional view of a therapy providing device in accordance with the present invention.

### DETAILED DESCRIPTION

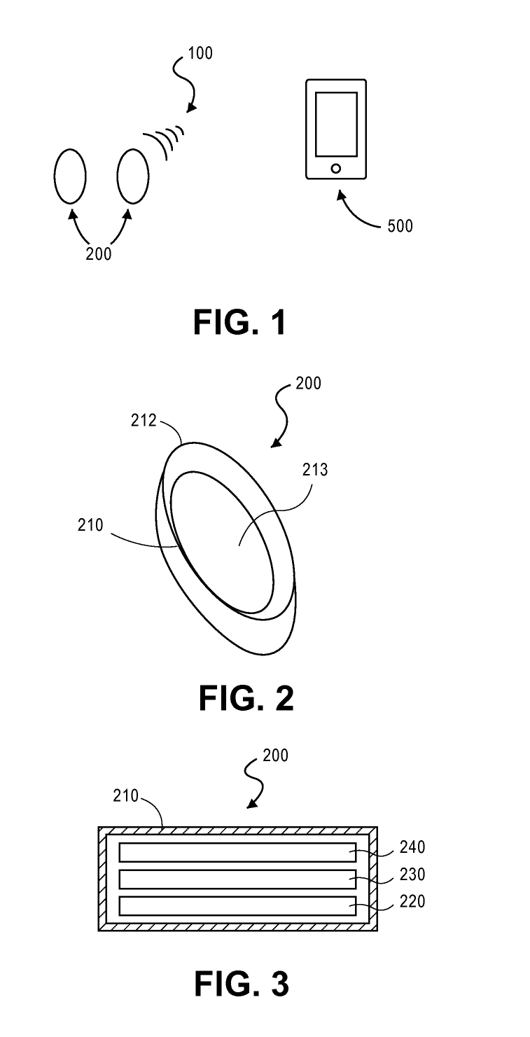

Referring now to FIG. 1, there is shown the therapy system 100 in accordance with the present invention. As shown in FIG. 1, the therapy system 100 includes a therapy providing device 200 and a computing device 800. As shown in FIG. 1, the computing device 800 is configured to communicate with the therapy device through a wireless communication protocol such as through the use of wifi, Bluetooth, zigbee, rfid, ANT+, infrared or other known wireless communication protocols. Alternatively, the computing device 800 and the therapy providing device 200 may be communicatively coupled together using a physical connection such as a wire, cable, fiber optic or using other known physical connections capable of transmitting electronic signals between devices. As shown in FIG. 1, it is contemplated that the methods according to the present invention would utilize two therapy providing devices 200 as shown. The two therapy providing devices 200 can be coupled together utilizing a cable connection or a wireless connection.

Referring now to FIG. 2, there is shown an exemplary embodiment of a therapy device in accordance with the present invention. As shown in FIG. 2, the therapy device 200 includes a housing 210, the housing having a proximal end 212 and a distal end 211 and defining a volume 213 therebetween. The housing may further have a first surface 214 and a second surface 215, at least one of the surfaces would be integrally formed during the manufacture of the housing 210, wherein the other surface would be attached to the housing using screws, glue, ultrasonic welding, welding or other know techniques. The housing may be constructed of biocompatible materials such as plastics or metals. The housing 210 may be machined or formed using other manufacturing processes such as injection molding.

It is if further contemplated that one surface of the housing may be shaped or contoured to be received by a patient's back or knee area. The shaped surface may be in the form of a concave or convex shape. Further still, one surface of the housing may include a deformable structure, such that when the housing is placed over the patient's back or knee the housing conforms to the patient's anatomy. In yet another embodiment, the housing may be custom formed to each individual user through the application of heat, whereby the housing or a portion of the housing is heated up and then pressed onto the patient, the heated portion of the housing conforming to the patient's anatomy. It is further contemplated that the housing includes an enlarged surface that can be ground or machined away to conform to the patient's anatomy. Further still, a mold may be taken of the patient's anatomy, whereby a housing can then be manufactured from the mold.

Referring now to FIG. 3 there is shown a cross-sectional view of the therapy device 200 described above and shown in FIGS. 1 and 2. As shown in FIG. 3, the therapy device 200 further includes a driver assembly 220 disposed within the volume 213 of the housing 210. The driver assembly may comprise a conventional coil speaker, an ultrasonic generator, a piezoelectric speaker, a pneumatic device, a suction device, a mechanical vibratory device, a hydraulic actuation device, or a photo acoustic excitation device.

The mechanical vibratory device is a motor coupled to a weighted member. The weighted member is coupled to the motor in an off-center manner, thereby creating an out of balance condition. When the motor is power, the out of balance condition causes the motor and weighted member to vibrate.

It is contemplated that the driver assembly is configured to provide vibrations, sound waves or other waveforms having a frequency in the range of 0 to 20,000 Hz, preferably 1 to 100 Hz and more preferably 10 to 60 and most preferably 15 to 45 Hz. The therapy may be provided for a time period between 1 minute and 24 hours, 1 day to 7 days a week.

As shown in FIG. 3, the therapy device further includes an electronics module 230. The electronics module includes a communication chip or chipset 235 (not shown). The communication chip may be Bluetooth, wifi, zigbee, Ant+, infrared, 3G/4G, CDMA, TDMA or other know wireless communication protocols. Alternatively, the communication chip 235 may control a wired connection such as a USB connection, firewire, thunderbolt, serial or parallel port.

As shown in FIG. 3, the therapy device further includes an energy source 240. The energy source may be in the form of a battery pack. The battery pack may be a rechargeable pack or a single use pack which may be embodied as gel batteries or absorbed glass mat batteries. Suitable examples of batteries that may comprise the pack are lithium ion (Li-ion), lead-acid, nickel-cadmium (NiCd), nickel-zinc (NiZn), zinc-oxide, nickel metal hydride (NiMH), Lithium ferrous-oxide (LiFo) or other known battery technologies. It is further contemplated that instead of utilizing a battery for an energy source a capacitor and related circuitry could be utilized.

The battery pack may be embodied in the form of a fabricated pack, where individual cells are soldered together, or alternatively, the battery pack could be arranged to utilize conventional battery sizes such as AAA, AA, CR2032, LR44, 9-volt, A23 and the like.

It is further contemplated that the battery pack may be further divided into a primary battery pack and a backup battery pack. In use, the primary battery would be initially utilized, if the pack malfunctions or loses its charge or its charge is used, the backup battery pack would then be enabled to continue the therapy.

If the battery pack as described above is chosen to be a rechargeable, there is a need to provide a charging circuit within the electronics module 230. The charging circuit may utilize either a physical plug connection to enable charging or may use a non-contact or inductive charging arrangement. If a physical plug arrangement is utilized, the plug may be selected to be a USB style plug, therefore it can be utilized both for charging as well as communication as described above.

If a non-contact charging arrangement is selected, then the electronics module 230 as described above and shown in FIG. 3 would further include the necessary electrical chip(s) and circuits to enable the non-contact charging circuit. Suitable examples of a non-conductive or inductive charging would utilize an electromagnetic field to transfer energy between the charger and the battery pack. In this embodiment a charging station would be provided in which the therapy providing device 200 could be stored. Therefore when the therapy device is placed within the storage container, the therapy device(s) 200 would be automatically charged. It is also contemplated that the storage container may be a smart container, which may contain a microprocessor and/or a wireless communication chipset. Thus, once the therapy device is removed from the storage container, the integrated wireless chipset within the storage container will cause the therapy device to power on.

In yet another embodiment, it is contemplated that the energy source 240 may be embodied in the form of an integrated generator, wherein the generator would be configured to create energy from movement of the therapy providing device 200, much like and automatic watch movement.

Referring back now to FIG. 1 there is shown a computing device 800 in accordance with the present invention. The computing device 800 includes a processor, memory, energy source (such as a battery), and a display. The computing device may be a custom manufactured device for use with the therapy device 200 as described above, or alternatively, the computing device 800 may be a commercially available device such as a smartphone or tablet. Examples of such commercially available devices are iOS enabled devices such as the iPhone®, iPad®, iPod®, Android based phones and/or tablets, laptops or computers.

In accordance with the present invention, the computing device 800 runs a program. The program is configured to communicate with the therapy device 200. The communication between the program, computing device 800 and the therapy device 200 may be conducted using Bluetooth, wife, zigbee, ANT+, 3G/4G, cellular connection or other known wireless communication protocols. Alternatively, the computing device may be coupled to at least one of the therapy devices through a cable connection.

In accordance with the present invention, methods of use of the present invention will be described below. The methods described will shall be considered to be exemplary and should not be considered limiting in any manner.

In one embodiment, the therapy providing device is powered on by the user by activating a switch on the therapy providing device. The user then places therapy providing device against their lower back or knee or other area exhibiting pain. The therapy providing device maybe affixed to the patient using a bandage wrapped around their body. Or alternatively, the device may be placed into a pouch on a belt, much like a back brace, and the belt disposed about their lower back. Further still, the therapy providing device may be configured to receive a removable adhesive patch, where, when applied to the device, the adhesive patch holds the therapy providing device onto the patient's skin.

In use, the therapy providing device is powered on, memory within the electronics module is pre-programmed to provide a therapy, wherein the driver assembly, such as a speaker, is energized to produce sound waves. The sound waves are generated having a frequency in the range of 0 to 20,000 Hz, preferably 1 to 100 Hz and more preferably 10 to 60 and most preferably 15 to 45 Hz. The therapy may be provided for a time period between 1 minute and 24 hours, 1 day to 7 days a week.

In an alternative embodiment, the therapy providing device is remotely powered on using the program 820 running on the computing device 800. The therapy providing device 200 is then placed onto the user. The user then uses the computing device 800 to control the therapy providing device 200 remotely.

Another aspect of the invention provides devices and methods for treating venous insufficiency. The device may be, e.g., the one shown in FIGS. 1-3 as described above. Because the treatment area is the clavicle, however, the housing 210 may be shaped or contoured to be received by a patient's clavicle or other desired treatment area. The shaped surface may be in the form of a concave shape. Further still, one surface of the housing may include a deformable structure, such that when the housing is placed over the patient's clavicle the housing conforms to the patient's anatomy.

In one embodiment in accordance with this aspect of the invention, the therapy device includes a speaker. The speaker may be a piezoelectric speaker or a magnetic coil speaker. The computing device 800 and program are configured to provide a signal to the speaker to cause the speaker to vibrate at certain frequencies or to oscillate or translate through a range of frequencies.

The user places the therapy providing device on their clavicle and activates the device manually or through the program on the computing device. It is contemplated that the driver is configured to provide vibrations, sound waves or other waveforms having a frequency in the range of 0 to 20,000 Hz, preferably 1 to 200 Hz and more preferably 100 and 160 Hz and most preferably 135 to 155 Hz. The therapy may be provided for a time period between 1 minute and 24 hours, 1 day to 7 days a week.

Through application of the acoustic wave, the insufficient venous valves are activated and are caused to pulse. This activation and pulsatile motion frees to valves or causes the valve(s) to function properly, thereby restoring normal flow within the vein.

Another aspect of the invention provides devices and methods for treating sexual dysfunction. In accordance with one embodiment of the invention, the device is designed to be temporarily worn by the user. The device may be, e.g., the one shown in FIGS. 1-3 as described above, except that one surface of the housing may be shaped or contoured to be received by a patient's pubic bone. The shaped surface may be in the form of a concave or convex shape. Once affixed to the patient, the device can be activated either manually or remotely through the use of a software program running on a computing device.

In use, the therapy providing device is powered on by the user by activating a switch on the therapy providing device. The user then places therapy providing device to the near the inguinal ligament. The vibrations generated by the therapy providing device are transmitted to the patient's nervous system, particularly the illoinguinal, genitofemoral, pudendal and/or postganglionic nerves, thereby causing the user to achieve an erection or arousal.

In a male the nerve endings are the dorsal nerve of the genitalia (DNP) and the perineal nerve (PN), the illoinguinal nerve, the genitofemoral nerve and the pudendal nerve, which are stimulated by using the device and method in accordance with the present invention.

The present invention targets the sensory nerves of the genitalia as well as those situated adjacent to the inguinal ligament to stimulate filling of blood vessels by a vibratory mechanism.

The present invention excites the sensory nerves of the skin and deeper tissues of the genitalia by a vibratory method. The vibrations may be generated using mechanical or acoustic devices.

The method of the present invention can be used in men whose cavernous nerves have been completely and permanently destroyed to preserve their sexual tissue integrity and length in anticipation of further intervention, such as penile prosthetic implants. The method of the present invention can also be used for obtaining sexual stimulation, orgasm and ejaculation.

The method of the present invention can further be used for retarding age-related sexual dysfunction and degeneration and age-related disuse atrophy and negative changes in penile nervous and sexual tissue. The method of the present invention can also be used for retarding chronic disease-related sexual dysfunction and degeneration and negative changes in penile nervous and sexual tissue. The chronic diseases include diabetes mellitus, chronic hypertension, peripheral vascular disease, high cholesterol, and atherosclerosis.

The on-demand (prior to or during sexual activity) application of the present invention is not limited to persons taking pro-sexual medication.

The apparatus and method according to the present invention also targets patients affected by natural aging and common medical disease processes for vibratory neuro-modulation to treat and retard deleterious effects of aging and such chronic medical diseases on sexual dysfunction.

In accordance with the present invention there is provided a device having a housing, the housing further including a driver assembly, an electronics assembly and an energy source. In use, the device is activated and placed at the pubic bone the vibrations generated by the driver assembly affect the user's nervous system resulting in an erection. The nerves affected by the vibrations are the illoinguinal nerve, the genitofemoral nerve, postganglionic nerve and/or pudendal nerve.

It is further contemplated that the device according to the present invention may also be beneficial to treat females and provide the ability to achieve orgasm. The device is placed on the pubic bone near the inguinal ligament. In use the device provides vibrations to the illoinguinal nerve, the genitofemoral nerve the postganglionic nerve, and/or the pudendal nerve which are believed to responsible for the excitation mechanism to achieve arousal.

In other embodiments, the invention described herein may also be to treat other disorders and conditions. In addition, other devices may be use to perform the methods described herein, such as, e.g., the devices described in US 2013/0102937, the disclosure of which is incorporated herein by reference.

1.-8. (canceled)

9. A method of treating pain comprising applying vibratory stimulation to the skin of a subject at a frequency of 0 to 100 Hz for a time period between 1 minute and 24 hours.

10. The method of claim 9 further comprising applying the vibratory stimulation for a time period between 1 day to 7 days a week.

11. A method of treating venous insufficiency comprising applying acoustic energy to a subject's clavicle and delivering acoustic energy to venous valves of the subject.

12. The method of claim 11 wherein the acoustic energy is provided at a frequency between 135 Hz and 155 Hz.

13.-15. (canceled)

16. A method of treating pain in a subject, the method comprising:
attaching a device to a skin surface of the subject; and
using the device to apply vibratory energy to the skin surface to treat the subject's pain; wherein the device comprises a housing, the housing having a proximal end, a distal end defining a volume therebetween, the housing further including a first surface and a second surface;
a driver member disposed within the volume of the housing;
an energy source disposed within the volume of the housing; and
an electronic module disposed within the volume of the housing, wherein the electronics module is coupled to the driver member and the energy source.

17. The method of claim 16 wherein the electronic module comprises a wireless communication module.

18. The method of claim 17 further comprising a computing device.

19. The method of claim 18 wherein the computing device further comprises a wireless communication module adapted to communicate with the electronic module.

20. The method of claim 18 wherein the computing device further comprises a software program configured to operate the driver member.

21. The method of claim 16 wherein the driver member is adapted to produce the vibratory energy at a frequency in the range of 0 Hz to 100 Hz.

22. The method of claim 16 wherein the driver member is adapted to produce the vibratory energy at a frequency in the range of 10 Hz to 60 Hz.

23. The method of claim 16 wherein the driver member is adapted to produce the vibratory energy at a frequency in the range of 15 Hz to 45 Hz.

24. The method of claim 16 wherein the pain treated is back or sciatic nerve pain.

25. The method of claim 16 wherein the pain treated is knee pain.
